(19) United States
(12) Patent Application Publication
(10) Pub. No.: US 2025/0127289 A1
(43) Pub. Date: Apr. 24, 2025

(54) Carrying device for a tool, in particular for a knife

(71) Applicant: MARTOR KG, Solingen (DE)

(72) Inventors: Martin ROHRBACH, Göggingen (DE); Kerry HENN, Solingen (DE)

(21) Appl. No.: 18/918,610

(22) Filed: Oct. 17, 2024

(30) Foreign Application Priority Data
Oct. 23, 2023 (DE) 10 2023 129 075.4

(51) Int. Cl. A45F 5/02

(52) U.S. Cl. CPC A45F 5/021; A45F 2005/027; A45F 5/1575

(57) ABSTRACT

A carrying device for a tool, including a receiving device with a receiving space for receiving the tool and with a retaining device for rotatably mounting and fastening the receiving device to a base part. The retaining device has a first retaining device associated with the receiving device and a second retaining device associated with the base part. A latch device includes a first latch associated with the receiving device and a second latch associated with the base part in order to latch the receiving device in different positions relative to the base part.

The invention relates to a carrying device for a tool, in particular for a knife.

For manual work, it is advantageous if the tool can be stored in a carrying device when not in use, which can be attached directly to the person—e.g. to clothing—or to an object within easy reach. Carrying devices are known from known prior use which have a receiving device with a receiving space for receiving a knife. The receiving device is firmly retained on a retaining device which can be attached to a belt. The carrying device allowed the receiving device to be moved relative to the retaining device.

The carrying device was in need of improvement as it is not configured to be resistant to soiling. Dirt particles could impair the function of the carrying device. In addition, the carrying device from prior art is in need of improvement with regard to its flexibility in mounting.

The object of the invention was to create a carrying device that is not susceptible to soiling. In addition, it was the object of the invention to create a carrying device that allows a high degree of flexibility with regard to its mounting.

The object was achieved by a carrying device with the features of claims 1.

The carrying device for a knife comprises a receiving device with a receiving space for holding the tool, in particular the knife. The receiving device is, for example, of pot-shaped design and has side walls and a base. The base does not have to be completely closed. The base and/or the side walls have openings, for example, through which dirt particles can leave the receiving space. The receiving device is provided with an opening for inserting the tool.

The carrying device comprises a retaining device for rotatable mounting and for releasable attachment of the receiving device to a base part, wherein the retaining device has first retaining means which are associated with the receiving device and second retaining means which are associated with the base part. The receiving device is detachably mounted on the base part by means of the retaining device. The retaining device allows repeated attachment and detachment of the receiving device from the base part. Once the receiving device has been attached to the base part, the receiving device is rotatably mounted on the base part and captively connected to it.

The carrying device comprises a latch device with first latch means associated with the receiving device and second latch means associated with the base part in order to lock the receiving device in different positions relative to the base part. The latch device ensures that the receiving device does not unintentionally move out of the set position relative to the base part. The range of rotation in which locking can take place is selectable and depends on the angular range in which locking of the receiving device relative to the base part is to take place.

For example, the second retaining means and the second latch means are associated with the base part. In this way, the carrying device can be configured with a small number of components.

The first retaining means and the second retaining means are configured, for example, as a clip device and can be detachably engaged with one another. In the context of the invention, clip device means that it is possible to detach and connect the receiving device and the base part without tools. With these features, it is possible to easily separate the receiving device from the retaining device and to reattach it. Clipping is carried out, for example, by locking with an elastically deformable latch on one of the parts, which can engage in a recess in the other part or engage behind the other part. During assembly, inclined surfaces on the latch, for example, cause elastic deformation when passing a latch wall and automatic movement of the latch into engagement with the latch seat due to the elastic restoring force.

The first or the second retaining means are formed, for example, by a circular recess in one of the parts of the receiving device and the base part, and the other retaining means are formed by at least two hook protrusions which engage through the recess, engage behind an edge region of the recess and can be moved radially inwards out of the engagement against elastic restoring force, such that the receiving device is detachable from the base part.

At least two hook protrusions have, for example, a bearing area which is configured in such a way that the entirety of the bearing areas of the hook protrusions forms an axis of rotation for rotatably mounting the receiving device on the base part. The bearing areas interact, for example, with a reveal of the opening to form the pivot bearing. For example, there may also be at least three or four hook protrusions, each of which has a bearing area.

The bearing areas have, for example, at least one web protrusion extending parallel to the pivot axis, which forms the contacting surface to the reveal of the opening. The web protrusion is configured as a strip, for example. With this feature, the friction between the bearing area and the reveal of the opening can be kept low, so that the rotation of the receiving device is not stiff.

The base part is of plate-shaped design, for example. Designing the base part in plate shape saves space, so that the retaining device can take up little space overall. Functional features such as retaining means, latch means or axle means can easily be provided on the plate-shaped base part. For example, the base part is configured as an injection-molded plastic part.

For example, each hook protrusion is mounted on at least one spring arm. The spring arm is, for example, released from the plane of the plate-shaped base part. In this way, the hook protrusions can be moved out of engagement with the other retaining means by elastic deformation of the respective spring arm in order to detach the receiving device from the base part.

The latch device is for example configured as a snap-in device. The term snap-in device is to be understood in the application in such a way that, after unlocking, the at least one latch automatically engages in a latch mating structure.

For example, the first latch means and the second latch means are formed by interacting toothings. The latching device is for example configured in such a way that the toothings allows a ratcheting adjustment in at least one adjustment direction. In the context of the invention, the term “ratcheting adjustment” means that during the engagement of the first latch means with the second latch means, an adjustment to another latching position is possible by exceeding a minimum adjustment force without actively moving a latch out of engagement. This adjustment is made possible by the fact that at least one latch of the first or second latch means is elastically deformable and the toothings of the latch means are configured in such a way that a force is generated towards the elastic deformability during adjustment.

The first latch means or the second latch means have, for example, a fixed toothing which is formed on the respective part. The respective other latch means have, for example, at least one elastically deformable tooth which-due to elastic restoring force—is loaded in engagement with the fixed toothing.

The first latch means or the second latch means are formed, for example, on at least one elastic arm. For example, each latch is retained on an elastically deformable arm. The arm is formed, for example, in the plane of a plate-shaped base part and is released from the base part in such a way that a free end region provided with the latch is elastically movable.

For example, the retaining device has a closing part which can be at least partially detachably fastened to the base part. With the closing part, it is possible to fasten the receiving device to a belt or a bar by arranging the belt or bar between the closing part and the base part and then fastening the closing part to the base part. At least partially detachable in the context of this feature means, for example, that one region of the closing part is detachable, while another region is permanently connected to the base part.

For example, the retaining device comprises a hinge part as a closing part. The term hinge part means that the hinge part can be moved relative to the base part in a hinge-like manner. For example, the base part and the hinge part form a hinge joint. The hinge part can, for example, have an elastically deformable region and can only be moved relative to the base part by elastic deformation. In this case, the hinge part and the base part only form regions of one part. One end region of the hinge part is, for example, movably or deformably connected to the base part, while another free end region can be removed from the base part.

The hinge part can be attached to the base part by means of a fastening device, for example. The fastening device comprises, for example, first closing means that are associated with the base part and second closing means that are associated with the hinge part. One of the closing means is for example formed by a latch and the other closing means is formed by a latch seat for receiving the latch in a latching position. The latch seat can, for example, be formed by a recess which is provided with locking surfaces with which movement of the latch or the latch seat can be prevented when the latch and latch seat are engaged. The closing means can be moved into a release position in which they are disengaged. The latch or the latch seat are formed, for example, on an elastic element in order to be able to load them when engaged and move them out of engagement.

The fastening device is formed, for example, on an end region of the hinge part opposite the joint.

For example, the fastening device has at least one pair of latch and latch seat. In particular, for example, two pairs of latch and latch seat are provided. The movement into the release position is then ergonomically possible because the adjustment force for the adjustment of one latch can be configured as a counterforce to the adjustment force for the adjustment of the other latch.

The receiving device forms, for example, a guide surface on which the knife can be guided into the receiving space. In this way, the opening to the receiving space of the receiving device can be found without the user having to aim at the receiving device. In addition, damage to clothing or injury to the user during insertion of the tool is prevented.

The tool is in particular a knife.

Exemplary embodiments of the invention are described by way of example in the following description of the Figures, also with reference to the drawings. For the sake of clarity, identical or comparable parts or elements or areas are designated with the same reference characters, sometimes with the addition of lowercase letters, even where different exemplary embodiments are concerned.

Features that are only described with reference to one exemplary embodiment can also be provided within the scope of the invention in any other exemplary embodiment of the invention. Such modified exemplary embodiments, even if not shown in the drawings, are included within the scope of the invention.

All disclosed features are per se essential to the invention. The disclosure of the application hereby also includes the disclosure content of the associated priority documents (copy of the prior application) as well as the cited publications and the described prior art devices in their entirety, also for the purpose of including individual or several features of these documents in one or several claims of the present application.

The Figures show in:

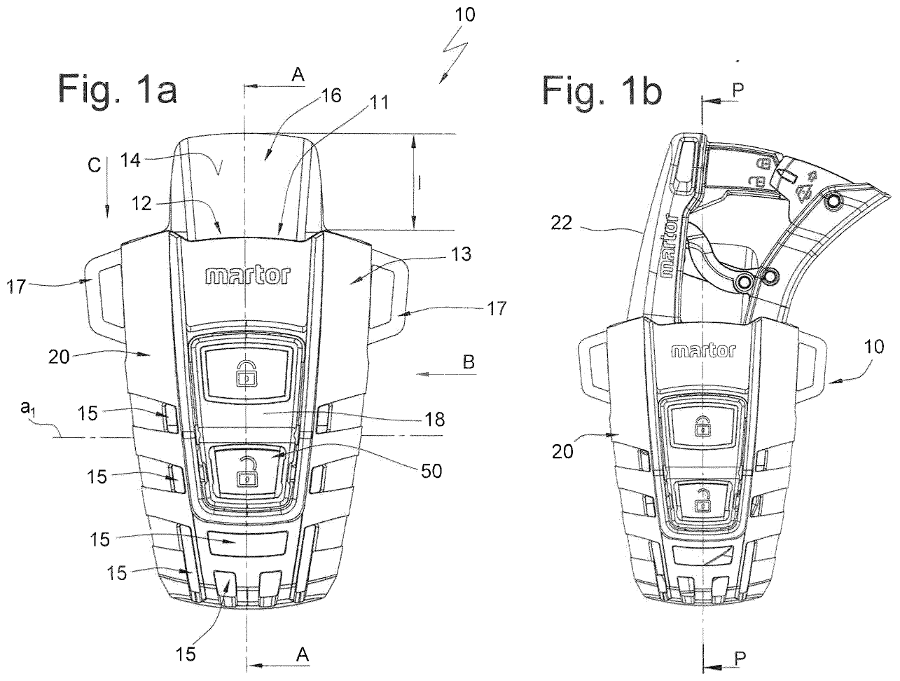

FIG. 1a a front view of the carrying device,

FIG. 1b the front view as shown in FIG. 1a, with a knife retained in the carrying device,

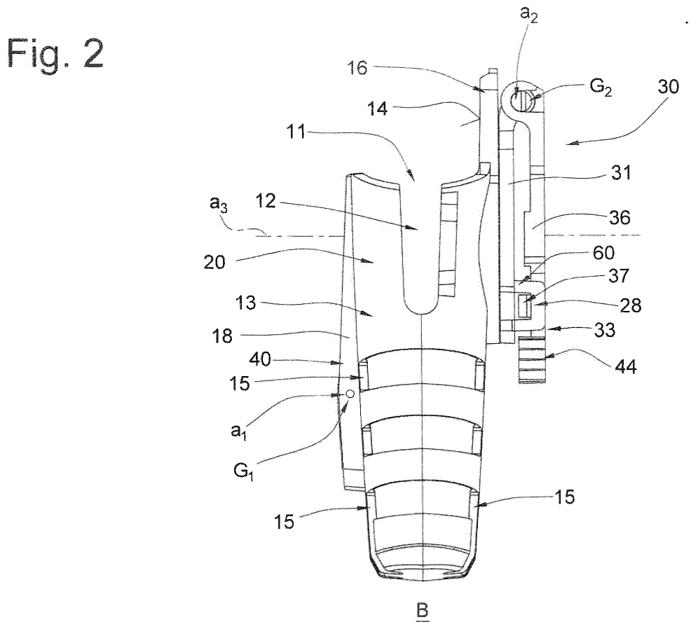

FIG. 2 a view according to view arrow B in FIG. 1a,

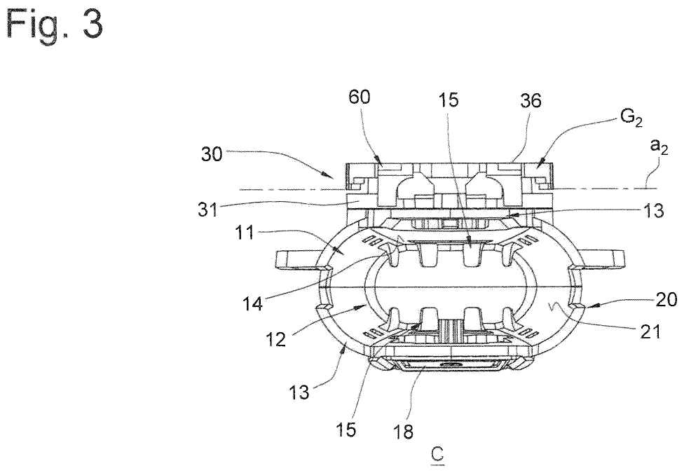

FIG. 3 a view according to view arrow C in FIG. 1a,

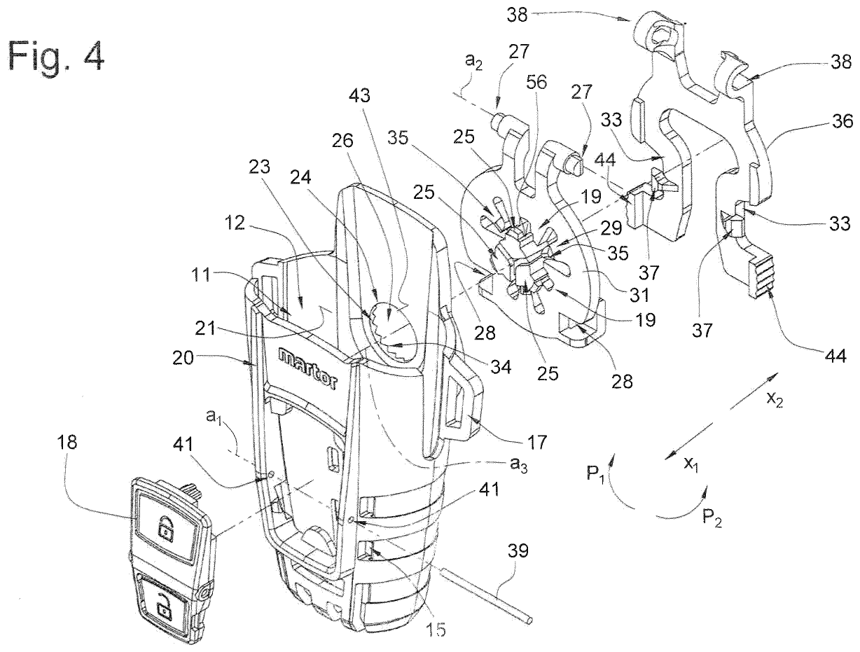

FIG. 4 an exploded view of the carrying device,

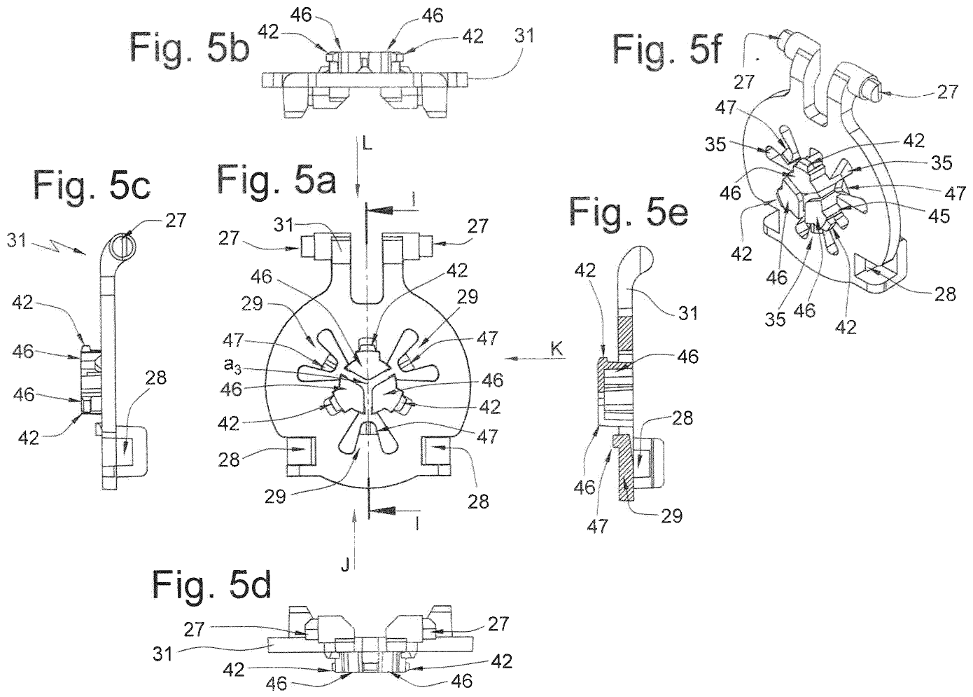

FIG. 5a a front view of a base part of the retaining device in a detailed view of the part,

FIG. 5b a view according to view arrow J in FIG. 5a,

FIG. 5c a view according to view arrow K in FIG. 5a,

FIG. 5d a view according to view arrow L in FIG. 5a,

FIG. 5e a sectional view according to sectional line I-I in FIG. 5a, FIG. 5f a perspective view of the base part,

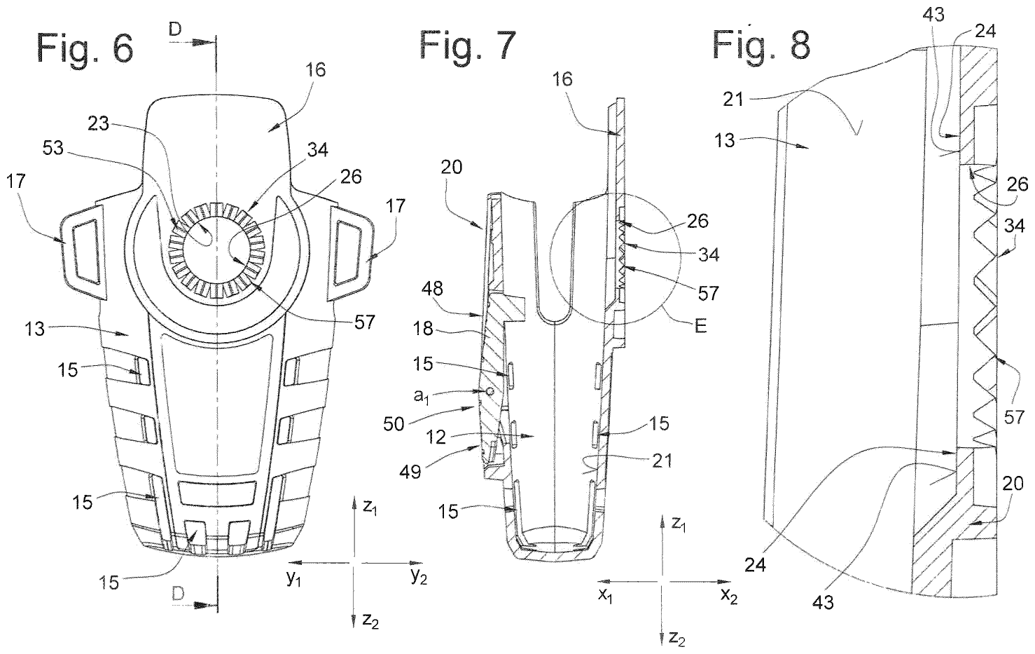

FIG. 6 a rear view of the receiving device of the carrying device without the retaining device,

FIG. 7 a sectional view according to sectional line D-D in FIG. 6,

FIG. 8 an enlarged illustration of detail E in FIG. 7,

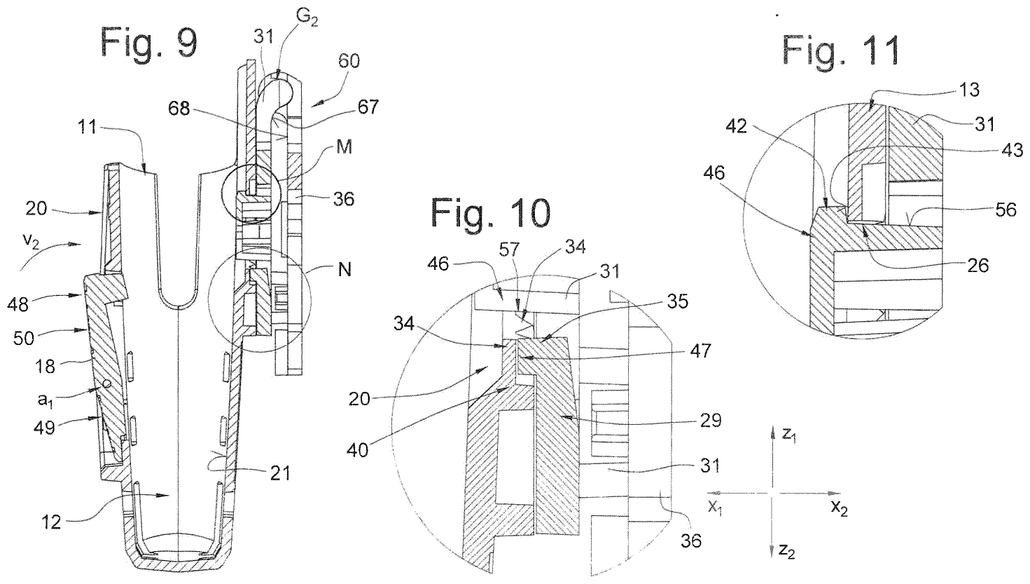

FIG. 9 a sectional view according to sectional line A-A in FIG. 1,

FIG. 10 an enlarged illustration of the detail M in FIG. 9,

FIG. 11 is an enlarged illustration of detail N in FIG. 9,

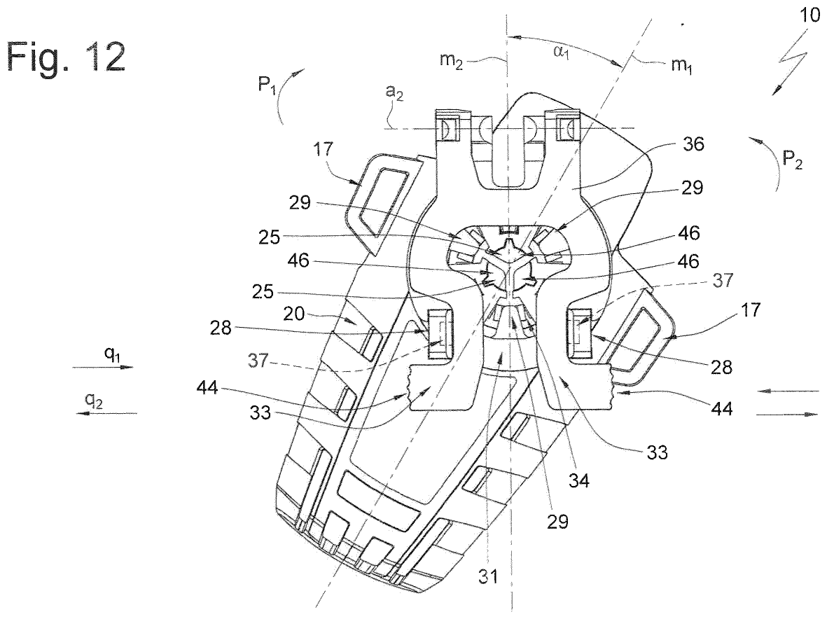

FIG. 12 a rear view of the carrying device, wherein the receiving device has a first angular position relative to the retaining device,

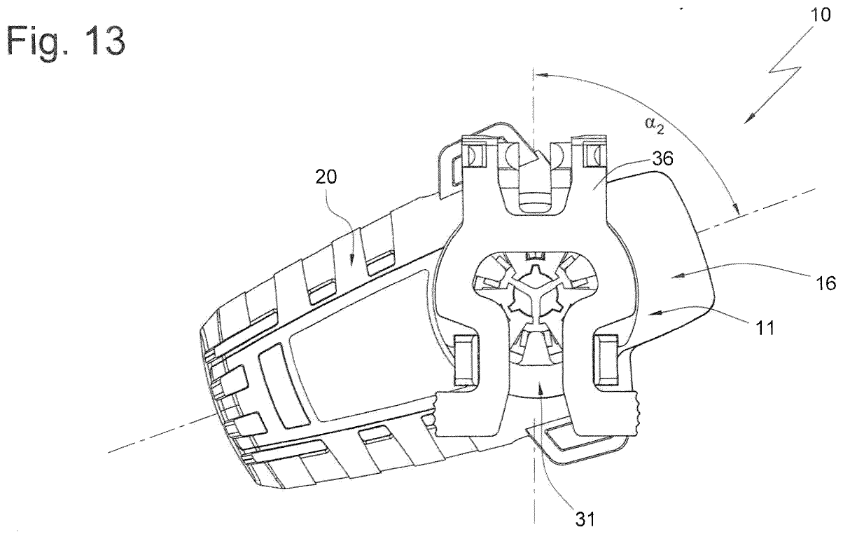

FIG. 13 a rear view of the carrying device, wherein the receiving device has a second angular position relative to the retaining device,

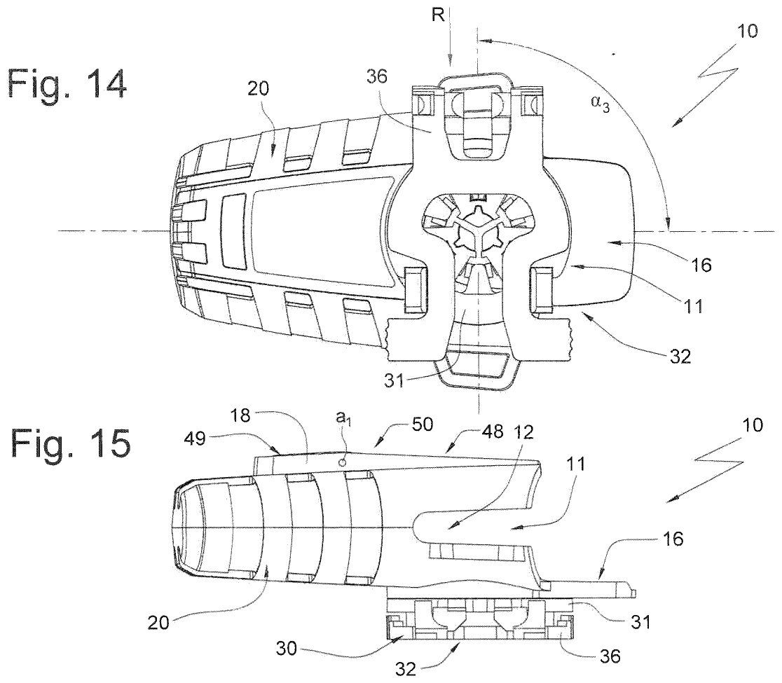

FIG. 14 a rear view of the carrying device, wherein receiving device the has a third angular position relative to the retaining device,

FIG. 15 a view according to view arrow R in FIGS. 14,

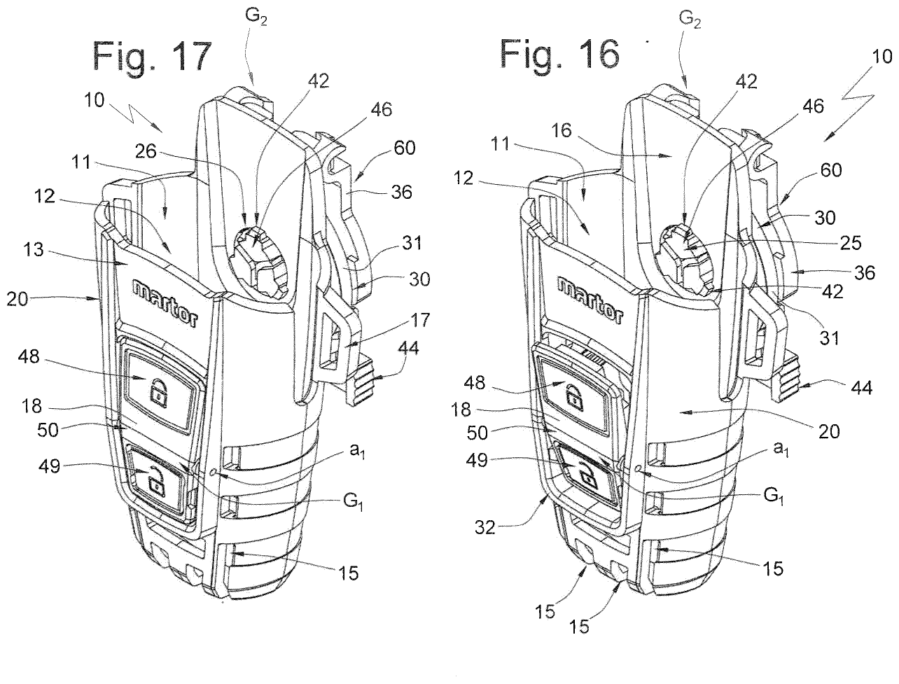

FIG. 16 a perspective view of the carrying device, wherein a button of a locking device is arranged in a locking position,

FIG. 17 a perspective view of the carrying device based on FIG. 16, with the button arranged in a release position,

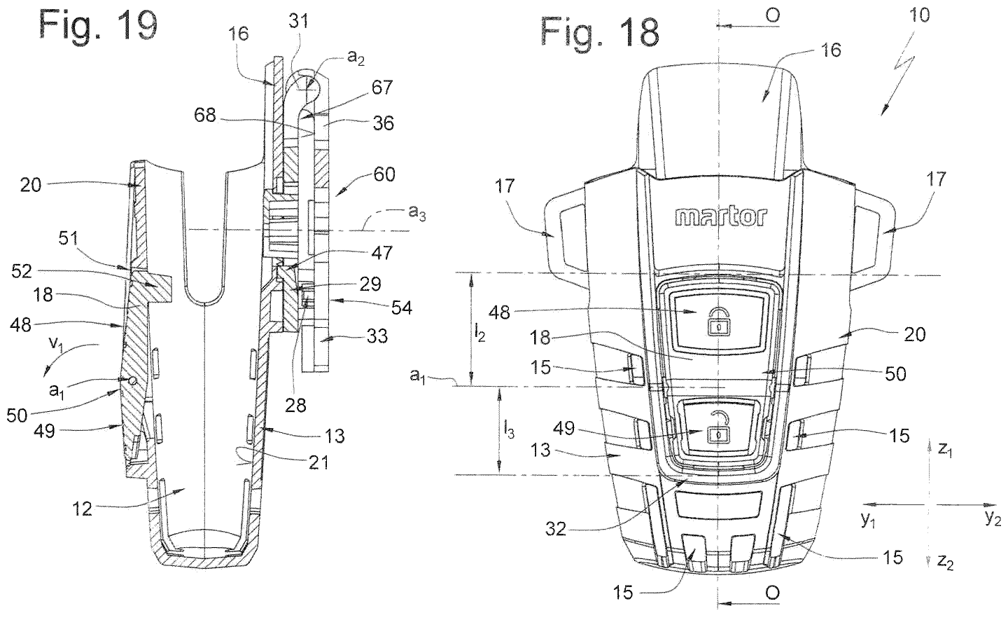

FIG. 18 a front view of the carrying device in the locking position,

FIG. 19 a sectional view according to sectional line O-O in FIG. 18,

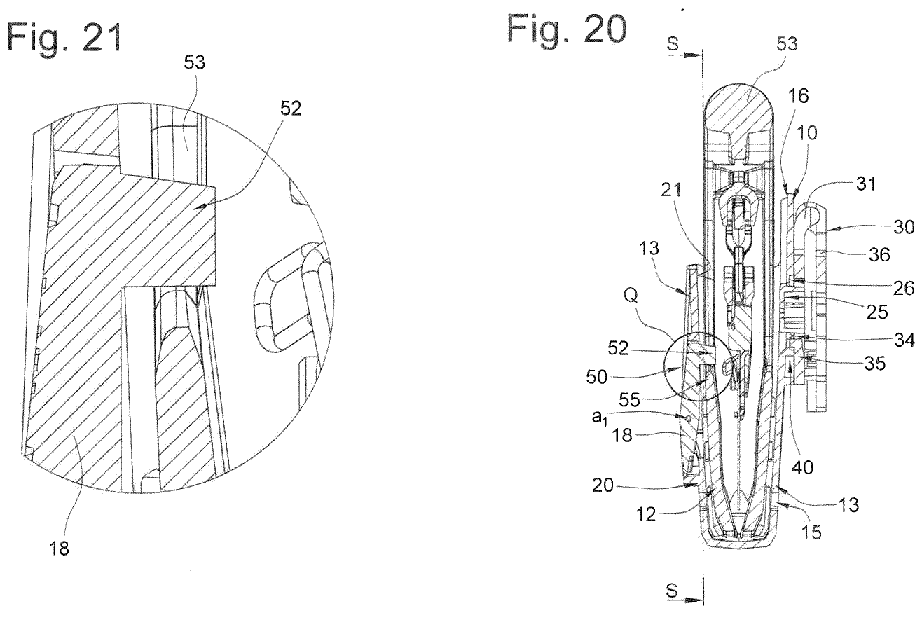

FIG. 20 a sectional view according to sectional line P-P in FIG. 1b,

FIG. 21 an enlarged illustration of section Q in FIG. 20,

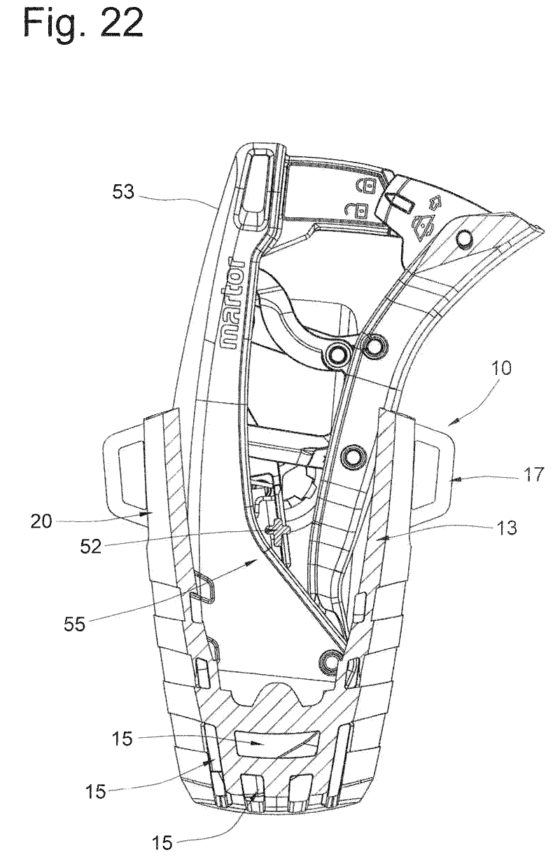

FIG. 22 a sectional view according to sectional line S-S in FIG. 20,

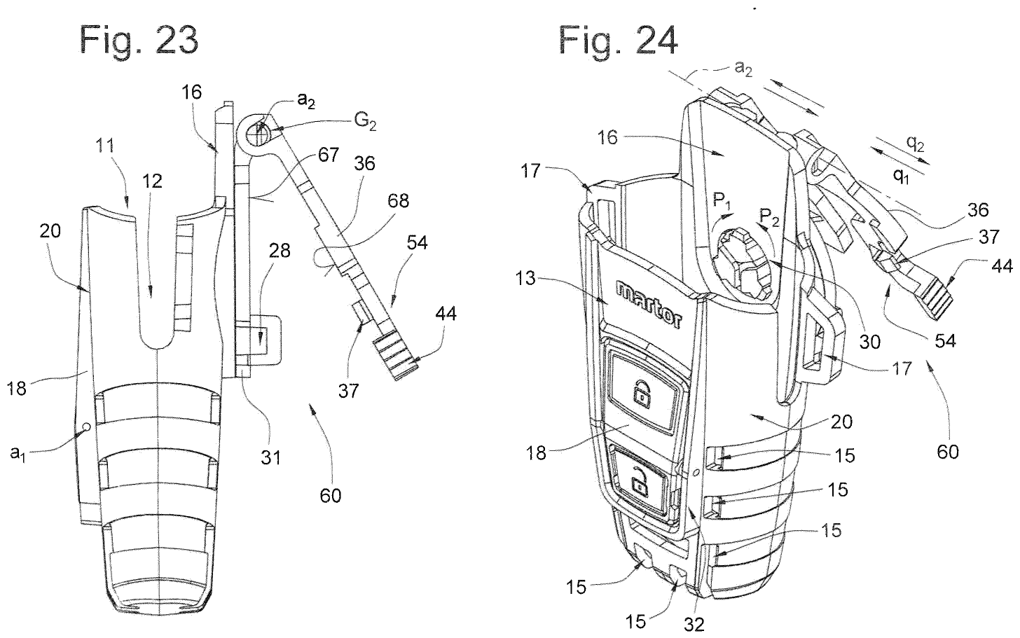

FIG. 23 a side view based on FIG. 2, where a hinge part of the fastening device is arranged in an open position,

FIG. 24 a perspective view of the carrying device according to FIG. 23.

A carrying device as a whole is designated by the reference character 10 in Figures. FIG. 1a shows a front view of the carrying device 10. The carrying device 10 is used to receive a tool, here in the form of a knife 22, as shown in FIG. 1b.

The carrying device 10 comprises a receiving device 20, a retaining device 30 and a latching device 40.

The receiving device 20 is configured like a housing and has a receiving space 12, which is delimited by a wall 13.

The knife can be inserted into and removed from the receiving space 12 via an upper opening 11. A wall area 16 forms a guide surface 14, which guides the knife 22 into the receiving space. An upper end of the wall 16 projects beyond an upper edge of the opening 11 with a length I.

Openings 15 in the wall 13 give the carrying device 10 a light appearance and allow dirt particles that have entered the receiving space 12 to escape. Fastening means in the form of eyelets 17 allow the fastening of a cable or strap not shown, which on the other hand is connected to the knife 22, or the fastening of other objects to the carrying device 10. The wall 13 is configured in such a way that contact with a cutting edge of the knife 22 and thus injury is not possible when the knife 22 is located in the receiving space 12. The receiving device 20 is essentially made of plastic, for example. Metal and composite plastics, for example, can also be used for the receiving device 20.

To secure the knife 22 in the receiving space 12 against unintentional falling out, the carrying device 10 in the present exemplary embodiment has a locking device 50. This comprises a button 18 with which the locking device 50 can be switched between a locking position and a release position. In the locking position, the knife 22 is secured in the receiving space 12 and in the release position, the knife 22 can be removed from the receiving space 12. In the present exemplary embodiment, the button 18 is configured as a rocker button that can be adjusted between the locking position and the release position. Alternatively, however, other actuations are also possible. The locking device 50 is explained in more detail below.

FIG. 2 shows a side view of the carrying device 10. A base part 31 can be seen, which is part of a retaining device 30 and part of a fastening device 60, e.g., for fastening the receiving device 20 to an item of clothing of the user or to a piece of furniture. The receiving device 20 is detachably attached to the base part 31 by means of the retaining device 30, which is not fully visible in FIG. 2, and is mounted on the base part 31 so that it can pivot about a pivot axis a3. In this example, the bearing is configured as a journal bearing.

Alternatively, other bearings could be used. In this case, however, a journal bearing offers the possibility of easy detachment of the receiving device 20 from the base part 31 and only incurs low costs.

In this exemplary embodiment, the receiving device 30 can be pivoted through 360° relative to the base part 31. Alternatively, however, the swivel radius could be limited.

FIG. 3 shows a top view of the carrying device in which the receiving space 12 can be seen through the opening 11. Openings 15 can be seen at the bottom of the receiving device 20, through which dirt particles can leave the receiving space 12.

FIG. 4 shows an exploded view of the carrying device 10. FIG. 4 shows the button 18, the receiving device 20, the base part 31 and a closing part 36. The base part 31 has second retaining means 25, which interact with first retaining means 24 of the receiving device in order to ensure detachable fastening and rotatable mounting. The first retaining means 24 are formed by an edge surface 43 of a recess 26 in the wall 13 of the receiving device 20. The edge surface 43 is part of an inner surface 21 of the receiving device 20. In other words, the edge surface 43 surrounds the recess 26 and, together with hook protrusions 42 of the base part 31, prevents the base part 31 from detaching from the receiving device 20.

In this exemplary embodiment, the second retaining means 25 are formed in the form of three separate blocks 46, which project from the plate-shaped base part 31 in the direction x1 towards the receiving device 20, each block 46 being mounted on an end region of at least one spring web 19, which is elastically deformable. In this way, each block 46 can be moved radially inwards against the elastic spring force of the spring web 19. Spaces between the blocks 46 allow the movement radially inwards. A bearing surface 56 of all three blocks 46 together produces the shape of a circular cylinder, which is intended to engage through the recess 26 and form a common bearing surface for the pivot bearing. The number of blocks was selected by way of example in this case. Alternatively, there could also be 2 or 4 blocks 46, for example, the bearing surfaces 56 of which form a common bearing surface for rotationally supporting the receiving device 20.

Each block 46 is provided with a hook protrusion 42 (see FIG. 5a), which projects radially outwardly from a free end portion of each block 46. When each block 46 is elastically moved inwardly, the blocks 46 can be guided through the recess 26 in the direction x1 when the receiving device 20 is mounted on the base part 31. When the load is released, the blocks move radially outwardly with each hook protrusion 42 engaging over the edge surface 43 of the recess 26 on a side of the wall 13 opposite the base part 31. If this is the case, the base part 31 cannot be moved in direction x2 and released from the receiving device 20. The rotatability of the receiving device 20 relative to the base part 31 in the directions p1 and p2 is ensured due to the bearing surface 56 interacting with the reveal 23.

Oblique surfaces on the hook protrusions 42 support the radial inward movement in direction x1 relative to the receiving device 20 during assembly of the base part 31 when these come into contact with the reveal 23 of the recess 26. To remove the base part 31, the blocks 46 can be moved radially inwards by pressing on their common center (pivot axis a3) and then the retaining means 25 can be released from the receiving device 20 in direction x2. This detachability of the receiving device 20 from the base part 31 enables and simplifies cleaning of the carrying device 10.

On the bearing surface 56, each of the three blocks 46 has web projections 45 extending in the direction parallel to the pivot axis a3. When the first retaining means 24 are in engagement with the second retaining means 25, these are in contact with the reveal 23 of the recess 26 and together with the latter form a journal bearing for rotatably mounting the receiving device 20 relative to the base part 31 in the directions p1 and p2 about the pivot axis a3.

The latching device 40 of the carrying device 10 is configured to secure the set rotational position of the receiving device 20 relative to the base part 31. The latching device 40 has first latch means 34 (see FIGS. 6 to 11), which are associated with the receiving device 20, and second latch means 35, which are associated with the base part 31. In this exemplary embodiment, the second latch means 35 (see also FIGS. 5a to 5f) have a tooth protrusion 47 extending in the direction x1, which is directed towards the first latch means 34.

The tooth projection 47 is formed on a free end region of a spring web 29, which is exposed in the plane of the plate-shaped base part 31. In the present example, the second latch means have three tooth protrusions 47, which are arranged offset by 120° distributed around the axis of rotation a3. Alternatively, a different number of tooth protrusions 47 can be selected. In the present construction, the second latch means 35 are arranged radially outside the axis of rotation a3 with respect to the second retaining means 25, which is advantageous in terms of a space-saving design.

FIG. 6 shows a view from the rear of the receiving device 20. It can be seen that the first latch means 34 are formed by a toothing 57, which surrounds the recess 26 or, in other words, is formed on an edge region 53 of the recess 26 facing the base part 31. In the present example, the toothing is formed over an angle of 360° relative to the axis of rotation a3. This enables locking in all rotational positions of the receiving device 20 relative to the base part 31 over an angle of 360°. If less adjustment of the receiving device 20 is desired, the first latch means 34 can also be formed only at a smaller angle, for example 90° from the vertical in both directions of rotation p1 and p2.

FIGS. 7 and 8 show that the toothing 57 occupies little installation space and the extension in the direction x1 and x2 is small.

FIGS. 10 and 11 show details of the retaining device 30 and the latching device 40. FIG. 10 shows the engagement of the tooth protrusion 47 in a recess of the toothing 57. The toothings 47 and 57 are configured here as a snap-in device, so that when a minimum torque on the receiving device 20 in one of the directions of rotation p1 or p2 is exceeded, the tooth protrusion 47 automatically moves in the direction x2 out of engagement with the toothing 57 and moves into engagement with the toothing 57 in the set rotational position due to the restoring force of the spring bar 29. FIG. 11 shows how the hook protrusion 42 detachably engages over the edge surface 43 in the latched position.

FIGS. 12 to 15 show different swivel positions of the receiving device 20 relative to the base part 31 by way of example. In FIG. 12, an angle α1 of approximately 30° is enclosed between a longitudinal central axis m1 of the receiving device 20 and a longitudinal central axis m2 of the base part 31. In FIG. 13, the angle α2 between the longitudinal central axes m1 and m2 is approximately 70° and in FIG. 14, the angle α3 between the longitudinal central axes m1 and m2 is approximately 90°.

The locking device 50 is explained below, by means of which the removal of the knife 22, which is held in the receiving space 12, can be prevented. The blocking device 50 comprises the button 18 which is pivotably mounted about a pivot axis a1. The geometric pivot axis a1 is formed by a physical axis 39 (only visible in FIG. 4), which is mounted in axle recesses 41 of the receiving device 20 and forms a joint G1 with the latter (see FIGS. 16 and 17).

The button 18 is configured as a two-armed lever and has two areas 48 and 49 according to FIG. 16, wherein the area 48 is located above the pivot axis a1 and the area 49 is located below the pivot axis a1. The actuation 18 can be moved in a rocker-like manner between a locked position and a released position by pressing on the respective area 48 or 49. FIG. 16 shows the released position and FIG. 17 the locked position. FIG. 18 shows a front view of the carrying device, with the locking device 50 in the locked position.

FIG. 18 shows that the area 48 has a greater longitudinal extension I2 from the pivot axis a1 in direction z than the area 49, which has a longitudinal extension I3. In addition, area 48 has a larger surface area than area 49. The locked position is therefore easier to adjust than the released position.

The button 18 is framed by a raised rim 32, which makes it stand out haptically and can be easily felt without having to aim at it.

In the sectional view according to FIG. 19, it can be seen that a locking pin 52 of the actuation 18 in the locked position reaches through an aperture 51 in the wall 13 of the receiving device 20 and engages in the receiving space 12. The button can be pivoted about the axis a1 in the directions v1 and v2. In the released position, which can be seen in the sectional view according to FIG. 9, the button 18 has been pivoted in the direction v1 in relation to the position according to FIG. 19 and the locking pin 52 barely protrudes into the receiving space 12. From the position according to FIG. 9, the locked position is achieved by pivoting in the direction v2.

FIGS. 19 to 22 show that the locking pin 52 is located in the motion trajectory of a knife 22 received in the receiving space 12—in this case a casing wall 55 of the knife 22—when the knife 22 is moved in the direction z2. Removal or unintentional falling out of the knife 22 is therefore impossible.

FIG. 23 shows a side view of the carrying device 10 with reference to FIG. 2, wherein a fastening device 60 is provided for fastening the carrying device 10 to a belt or a bar. This comprises a closing part 36, which forms a pivot joint G2 with the base part 31. The base part 31 forms primary joint means 27 for this purpose, which interact with secondary joint means 38 of the closing part 36.

A free end region 54 of the closing part 36 can be pivoted away from the base part 31 relative to the base part 31 about the pivot axis a2 by means of the pivot joint G2 (see FIGS. 23 and 24). According to FIG. 23, the closing part 36 has been pivoted away from the base part 31 so that a carrying part, for example a belt, can be arranged between a first contact surface 67 of the base part 31 and a second contact surface 68 of the closing part 36. The first contact surface 67 faces the second contact surface 68.

At the end region 54, the closing part 36 has two elastically deformable arms 33, each of which is formed with a closing protrusion 37. The arms 33 are elastically movable towards one another according to the arrows q1 in such a way that the closing protrusion 37 can be moved out of the locking relation of closing recesses 28 of the base part 31 by means of handles 44. By relieving the load on the handles 44, the closing protrusions 37 can move away from each other again in engagement with the closing recesses 28 due to elastic restoring force in accordance with the arrows q2.

In this way, the carrying device 10 can be secured, for example, to a belt 54 or to a web by arranging the latter between the base part 31 and the closing part 36, then bringing the closing part 36 into a parallel position to the base part 31 and then bringing the closing protrusions 37 into engagement with the closing recesses 28.

Alternatively, the joint G2 could also be configured as a film hinge, so that the base part 31 and the closing part 36 are integrally connected to one another. Alternatively, the closing part 36 and the base part 31 could also be formed integrally and connected by an elastic area that replaces the joint G2. In this case, the base part 31 and the closing part 36 would be connected in a clasp-like manner and the fastening device would not have a closing device comprising, for example, a closing projection and a closing recess.

1-16. (canceled)

17. A carrying device for a tool, comprising: a base part; a receiving device with a receiving space for receiving the tool; a retaining device that rotatably mounts and fastens the receiving device to the base part, wherein the retaining device includes a first retaining element associated with the receiving device, and a second retaining element associated with the base part; and, a latch device including a first latch associated with the receiving device, and a second latch associated with the base part so as to lock the receiving device in different positions relative to the base part.

18. The carrying device according to claim 17, wherein the first retaining element and the second retaining element are configured as a clip device that is engageable in a releasable manner.

19. The carrying device according to claim 17, wherein one of the first retaining element and the second retaining element is a circular recess, and the other of the first retaining element and the second retaining element is at least two hook protrusions that engage through the recess, engage behind an edge surface of the recess and are movable radially inwards out of engagement counter to an elastic restoring force so that the receiving device is detachable from the base part.

20. The carrying device according to claim 19, wherein the at least two hook protrusions each have a bearing surface, wherein an entirety of the bearing surfaces of the hook protrusions form an axis of rotation for rotatably mounting the receiving device on the base part.

21. The carrying device according to claim 17, wherein the base part is plate-shaped.

22. The carrying device according to claim 19, wherein each of the hook protrusions is mounted on at least one spring arm.

23. The carrying device according to claim 17, wherein the latch device is a snap-in device.

24. The carrying device according to claim 17, wherein the first latch or the second latch is formed by interacting toothings.

25. The carrying device according to claim 17, wherein the first latch or the second latch is formed on an elastic arm.

26. The carrying device according to claim 17, wherein the retaining device includes a closing part that is at least partially detachably fastened to the base part.

27. The carrying device according to claim 26, wherein the closing part is a hinge part that forms a joint with the base part.

28. The carrying device according to claim 27, further comprising a closing device that fastens the closing part to the base part.

29. The carrying device according to claim 28, wherein the closing device is formed on an end region of the closing part opposite the joint.

30. The carrying device according to claim 28, wherein the closing device includes a closing protrusion and a closing recess, wherein the closing protrusion is associated with one of the closing part and the base part and the closing recess is associated with the other of the closing part and the base part.

31. The carrying device according to claim 17, wherein the receiving device has a wall area that forms a guide surface on which the tool is guided into the receiving space.

32. The carrying device according to claim 17, wherein the tool is a knife or comprises a knife.
